(19) United States
(12) Patent Application Publication
(10) Pub. No.: US 2012/0149002 A1
(43) Pub. Date: Jun. 14, 2012

(54) EDUCATIONAL KIT FOR DISPLAY DEVICE AND EDUCATIONAL METHOD UTILIZING THE SAME

(75) Inventors: An-Bang Wang, Taipei City (TW); Hsi-Chun Wang, Taipei City (TW); Jiun-Haw Lee, Taipei City (TW); Guo-Dung Su, Taipei City (TW); Lin-Chi Chen, Taipei City (TW); Ching-Heng Tang, Taipei City (TW)

(73) Assignee: NATIONAL TAIWAN UNIVERSITY, Taipei (TW)

(21) Appl. No.: 13/405,192

(22) Filed: Feb. 24, 2012

Related U.S. Application Data
(63) Continuation-in-part of application No. 12/368,207, filed on Feb. 9, 2009.

(30) Foreign Application Priority Data
Nov. 6, 2008 (TW) TW97142820

(51) Int. Cl. G09B 25/00

(52) U.S. Cl. 434/365

(57) ABSTRACT

An educational kit for a display device and an educational method utilizing the same is provided. The educational kit includes an upper housing, a lower housing, a display panel module and a circuit control panel. The display panel module is disposed between the upper housing and the lower housing. The circuit control panel is disposed between the display panel module and the lower housing. The method includes providing an educational kit for a display device; disassembling the display device into a plurality of components; and reassembling the components to form the display device. The educational method is accomplished by disassembling and reassembling the display device.

### CROSS REFERENCE TO RELATED APPLICATIONS

This application is a Continuation-In-Part of pending U.S. patent application Ser. No. 12/368,207, filed Feb. 9, 2009 and entitled “Educational kit for display device and educational method utilizing the same, which claims priority of Taiwan Patent Application No. 097142820, filed on Nov. 6, 2008, the entirety of which is incorporated by reference herein.

### BACKGROUND OF THE INVENTION

1. Field of the Invention

The present invention relates to an educational kit for a display device and an educational method utilizing the educational kit.

2. Description of the Related Art

For a professional education of a display device, written descriptions, pictures, oral presentations and field trip to the manufactory are utilized to help students' understanding of the display device. However, it is still not clear enough for student to comprehend the working principles and the assembly method just by text books or slide shows. In addition, a visit to the manufactory does not help much because a safety distance must be kept during the manufacturing process that no contact is allowed during the visit. The above deficiencies may limit the dissemination of the professional education of a display device.

### BRIEF SUMMARY OF THE INVENTION

Accordingly, the present invention provides an educational kit for a display device. The educational kit comprises an upper housing, a lower housing, a display panel module and a circuit control panel. The display panel module is disposed between the upper housing and the lower housing. The circuit control panel is disposed between the display panel module and the lower housing. An educational method is accomplished by disassembling and reassembling the display device.

The invention provides an educational method. The method comprises providing an educational kit for a display device; disassembling the display device into a plurality of components; and reassembling the components to form the display device. The educational method is accomplished by disassembling and reassembling the display device.

### BRIEF DESCRIPTION OF THE DRAWINGS

The present invention can be more fully understood by reading the subsequent detailed description and examples with references made to the accompanying drawings, wherein:

FIG. 1 is a schematic view of an educational kit of the invention;

FIG. 2A is a flow chart showing an educational method of the invention;

FIG. 2B is a flow chart showing a detailed method of method M2 in FIG. 2A;

FIG. 2C is a flow chart showing a detailed method of method M8 in FIG. 2A;

FIG. 3 is a schematic view showing a backlight module and a circuit control panel of the invention;

FIG. 4 is a schematic view showing the backlight module, the circuit control panel and a brightness enhancement film of the invention;

FIG. 5 is a schematic view showing the backlight module, the circuit control panel and a diffusion film of the invention;

FIG. 6 is a schematic view showing the backlight module, the circuit control panel and a liquid crystal display panel of the invention;

FIG. 7A shows a display device of a modified embodiment of the invention;

FIG. 7B shows inner elements of the display device of the embodiment of FIG. 7A;

FIG. 7C shows a first polarizer detached from the display device of the display device of the embodiment of FIG. 7A;

FIG. 7D shows another modified embodiment of the invention; and

FIG. 8 shows a display device of another modified embodiment of the invention.

### DETAILED DESCRIPTION OF THE INVENTION

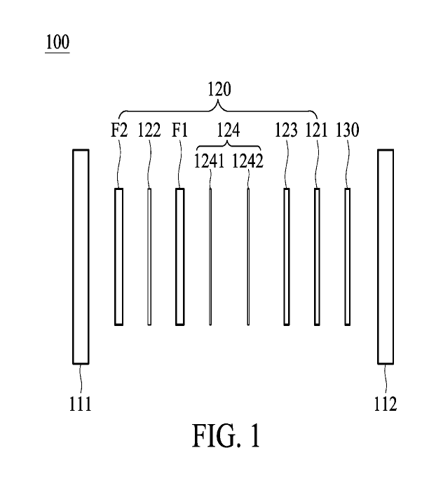

FIG. 1 is a schematic view of an educational kit of the invention. Referring to FIG. 1, the educational kit for a display device 100 comprises an upper housing 111, a lower housing 112, a display panel module 120 and a circuit control panel 130, wherein the educational kit is a 7-inch digital photo frame.

It should be noted that the educational kit 100 of the embodiment may further comprises a screwing member for connecting the above described components, or wires for coupling the above described components.

The display panel module 120 comprises a base 121, a liquid crystal display panel 122, a backlight module 123, two optical films 124 (a brightness enhancement film 1241 and a diffusion film 1242), a first frame F1 and a second frame F2. The liquid crystal display panel 122 is disposed in the base 121. The backlight module 123 is disposed between the liquid crystal display panel 122 and the base 121. The optical films 124 are disposed between the liquid crystal display panel 122 and the backlight module 123. The optical films 124 are secured on the backlight module 123 by the first frame F1, and the liquid crystal display panel 122 is secured on the backlight module 123 by the second frame F2.

The display panel module 120 is disposed between the upper housing 111 and the lower housing 112. The circuit control panel 130 is disposed between the display panel module 120 and the lower housing 112. Additionally, the circuit control panel 130 electrically connects to the liquid crystal display panel 122 and the backlight module 123 of the display panel module 120.

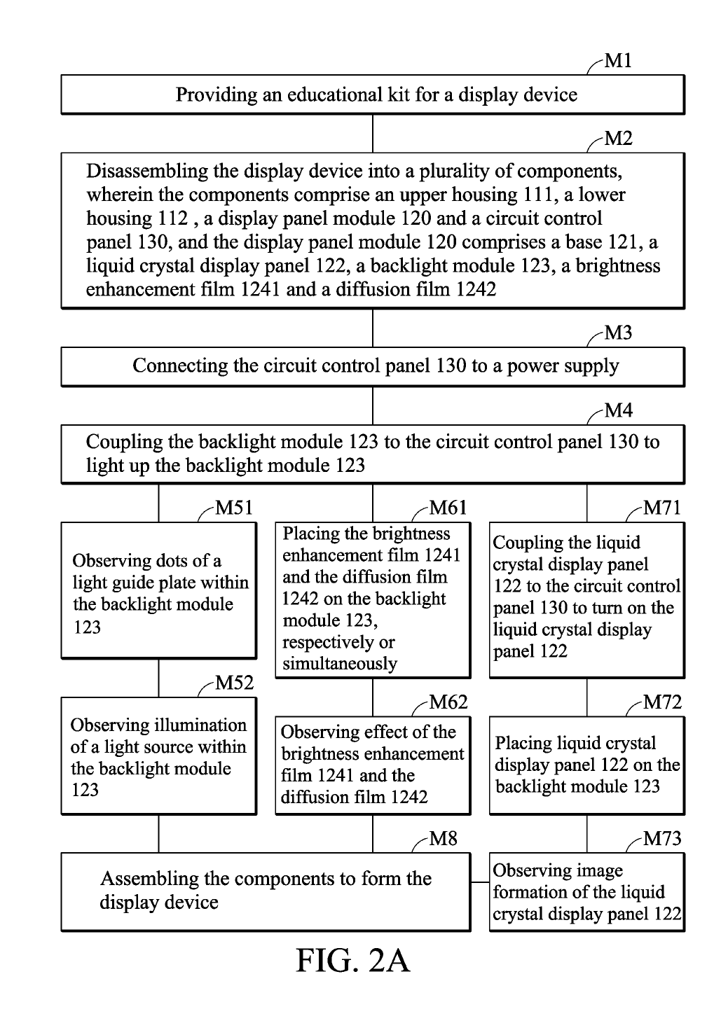

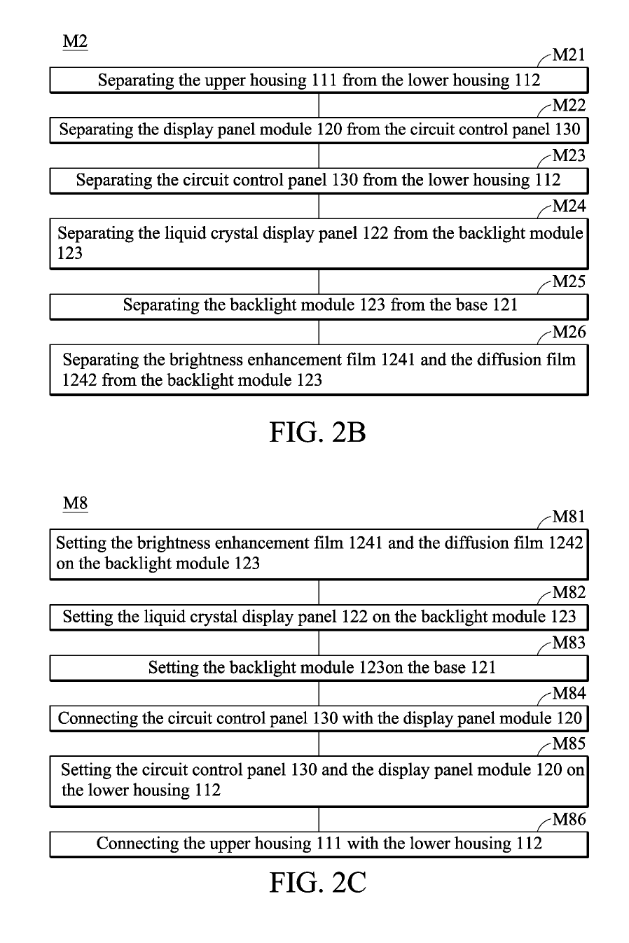

Furthermore, an educational method for assembly and experimentation of the display device can be performed during disassembly and reassembly of the display device. Referring to FIGS. 2A-2C, FIG. 2A is a flow chart showing an educational method of the invention, FIG. 2B is a flow chart showing a detailed method of method M2 in FIG. 2A, and FIG. 2C is a flow chart showing a detailed method of method M8 in FIG. 2A.

As shown in FIG. 2A, the educational method comprises M1˜ providing an educational kit for a display device, and M2˜ disassembling the display device into a plurality of components, wherein the components comprise an upper housing 111, a lower housing 112, a display panel module 120 and a circuit control panel 130, and the display panel module 120 comprises a base 121, a liquid crystal display panel 122, a backlight module 123, a brightness enhancement film 1241 and a diffusion film 1242 (as shown in FIG. 1).

As shown in FIG. 2B, the step of M2 comprises M21˜ separating the upper housing 111 from the lower housing 112, M22˜ separating the display panel module 120 from the circuit control panel 130, M23˜ separating the circuit control panel 130 from the lower housing 112, M24˜ separating the liquid crystal display panel 122 from the backlight module 123, M25˜ separating the backlight module 123 from the base 121, and M26˜ separating the brightness enhancement film 1241 and the diffusion film 1242 from the backlight module 123.

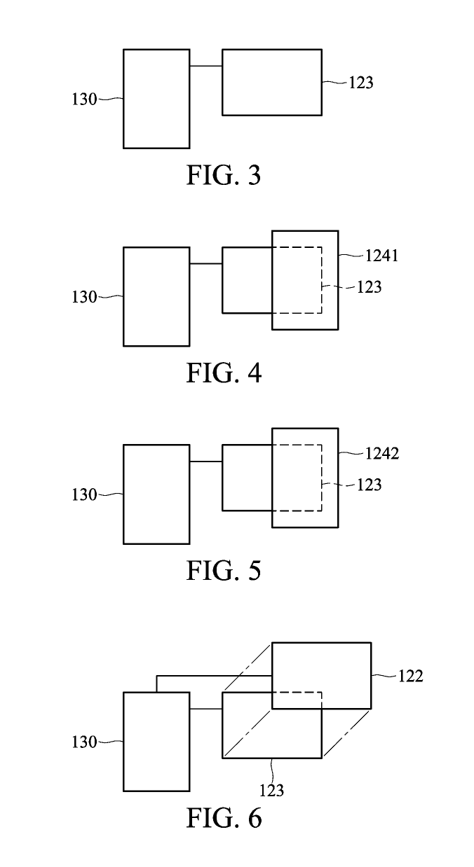

FIG. 3 is a schematic view showing a backlight module and a circuit control panel of the invention. FIG. 4 is a schematic view showing the backlight module, the circuit control panel and a brightness enhancement film of the invention. FIG. 5 is a schematic view showing the backlight module, the circuit control panel and a diffusion film of the invention. FIG. 6 is a schematic view showing the backlight module, the circuit control panel and a liquid crystal display panel of the invention.

Referring to FIG. 2A and FIGS. 3-6, the next steps are M3˜ connecting the circuit control panel 130 to a power supply, and M4˜ coupling the backlight module 123 to the circuit control panel 130 to light up the backlight module 123 (as shown in FIG. 3). Afterward, the following experiments can be performed. M51˜ observing dots of a light guide plate within the backlight module 123, M52˜ observing illumination of a light source within the backlight module 123, or M61˜ placing the brightness enhancement film 1241 and the diffusion film 1242 on the backlight module 123, respectively or simultaneously, and then M62˜ observing effect of the brightness enhancement film 1241 and the diffusion film 1242 (as shown in FIGS. 4 and 5). Otherwise, M71˜ coupling the liquid crystal display panel 122 to the circuit control panel 130 to turn on the liquid crystal display panel 122, M72˜ placing the liquid crystal display panel 122 on the backlight module 123, and M73˜ observing image formation of the liquid crystal display panel 122 (as shown in FIG. 6). During the above experimentations, students may use a magnifier, a microscope or the naked eye to inspect the microstructures of the liquid crystal display panel 122, the brightness enhancement film 1241, the diffusion film 1242 and the backlight module 123.

Lastly, the step of M8˜ reassembling the components to form the display device is accomplished after the above experiments. Referring to FIG. 2C, the step of M8 comprises M81˜ setting the brightness enhancement film 1241 and the diffusion film 1242 on the backlight module 123, M82˜ setting the liquid crystal display panel 122 on the backlight module 123, M83˜ setting the backlight module 123 on the base 121, M84˜ connecting the circuit control panel 130 with the display panel module 120, M85˜ setting the circuit control panel 130 and the display panel module 120 on the lower housing 112, and M86˜ connecting the upper housing 111 with the lower housing 112.

The educational kit has the ability to accomplish educational purposes of assembly and experimentation of a display device when disassembling and reassembling the educational kit. By bringing text explanations and photographs into practice, student's learning, motivations and interests may be raised to promote learning efficiency. Moreover, the low cost and the simple assembly of the educational kit allows mass usage within the area of study.

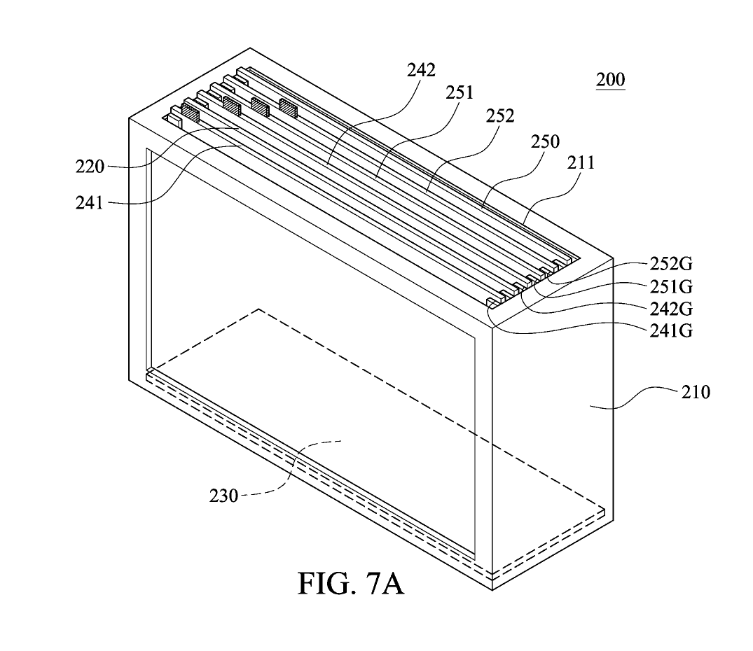

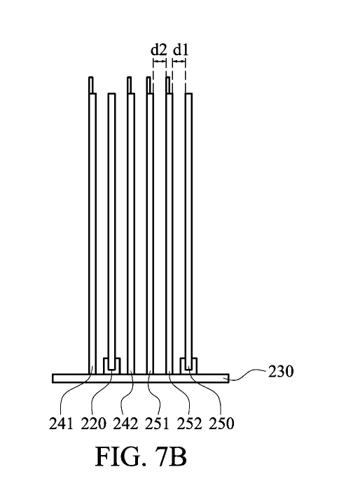

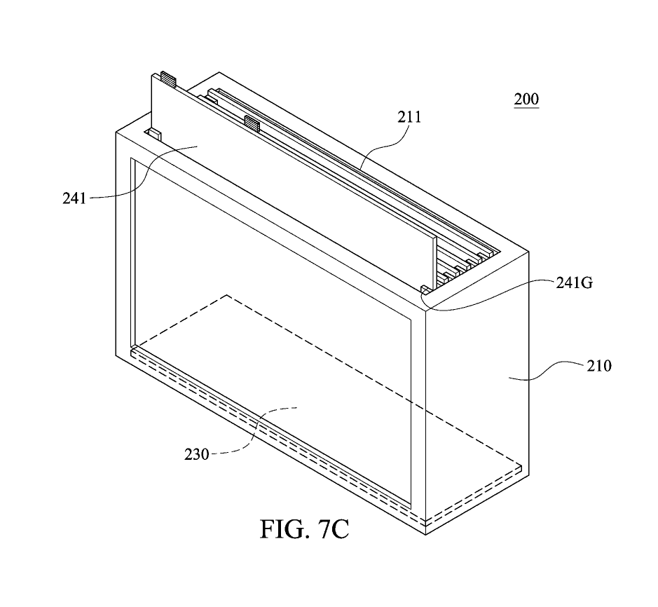

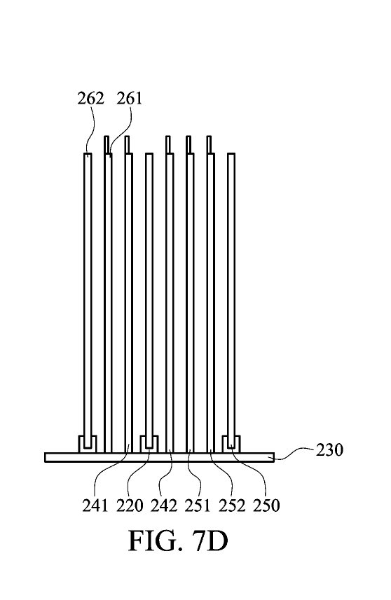

FIG. 7A shows a display device 200 of a modified embodiment of the invention, and FIG. 7B shows inner elements of the display device. With reference to FIGS. 7A and 7B, the display device 200 comprises a housing 210, a display panel 220, a circuit control panel 230, a first polarizer 241, a second polarizer 242, a backlight module 250, a brightness enhancement film 251 and a diffusion film 252. An opening 211 is formed on the housing 210, a first polarizer groove 241G is formed in the housing 210 communicated to the opening 211, and a second polarizer groove 242G is formed in the housing 210 communicated to the opening 211. The display panel 220 is disposed in the housing 210. The circuit control panel 230 is electrically connected to the display panel 220. The first polarizer 241 is detachably disposed in the housing 210, wherein the first polarizer 241 slides in the first polarizer groove 241G of the housing 210 relative to the display panel 220. The second polarizer 242 is detachably disposed in the housing 210, wherein the second polarizer 242 slides in the second polarizer groove 242G of the housing 210 relative to the display panel 220, wherein the display panel 220 is located between the first polarizer 241 and the second polarizer 242.

The circuit control panel 230 is disposed in the housing 210 and facing to the opening 211.

The backlight module 250 is disposed in the housing 210. The brightness enhancement film 251 is detachably disposed in the housing 210, wherein a brightness enhancement film groove 251G is formed in the housing 210 communicated to the opening 211, and the brightness enhancement film 251 slides in the brightness enhancement film groove 251G of the housing 210 relative to the backlight module 250. The diffusion film 252 is detachably disposed in the housing 210, wherein a diffusion film groove 252G is formed in the housing 210 communicated to the opening 211, and the diffusion film 252 slides in the diffusion film groove 252G of the housing 210 relative to the backlight module 250, wherein the brightness enhancement film 251 and the diffusion film 252 are located between the backlight module 250 and the second polarizer 242.

A first distance d1 is formed between the diffusion film 252 and the backlight module 250, and the first distance d1 is smaller than 5 mm

A second distance d2 is formed between the brightness enhancement film 251 and the diffusion film 252, and the second distance is smaller than 5 mm

With reference to FIG. 7C, utilizing the display device 200 of a modified embodiment, the first polarizer 241, the second polarizer 242, the brightness enhancement film 251 and the diffusion film 252 can be detached from the display device 200, and the functions of each element can be easily understood by students.

FIG. 7D shows another modified embodiment of the invention, wherein a lenticular lens member 261 is detachably disposed in the housing 210, and slides relative to the display panel 220, wherein the first polarizer 241 is located between the display panel 220 and the lenticular lens member 261. Additionally, a touch panel 262 is disposed in the housing 210 and electrically connected to the circuit control panel 230, wherein the first polarizer 241 is located between the display panel 220 and the touch panel 262.

The first polarizer 241 can be circular polarized.

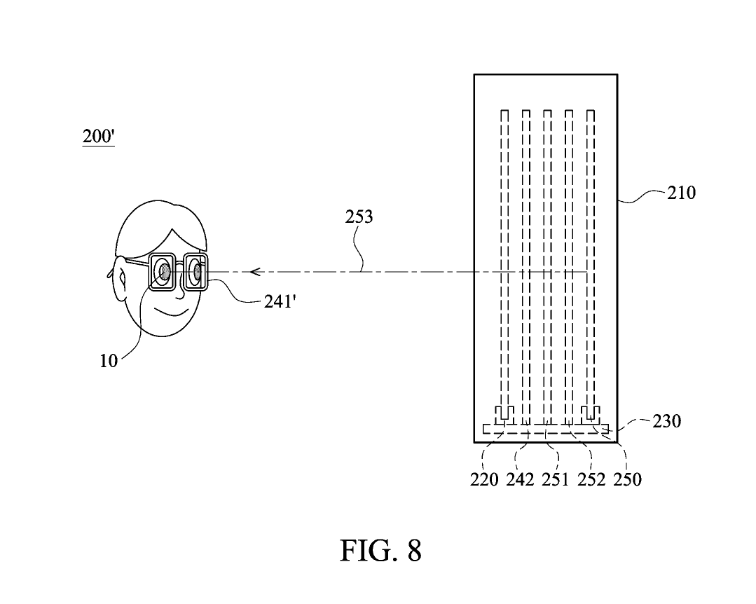

FIG. 8 shows a display device 200′ of another modified embodiment of the invention, which comprises a backlight module 250, a housing 210, a display panel 220, a circuit control panel 230, a polarizer 242, a polarizing glasses 241′, a diffusion film 252 and a brightness enhancement film 251. The backlight module 250 provides a light 253. The display panel 220 is disposed in the housing 210. The circuit control panel 230 is electrically connected to the display panel 220. The polarizer 242 is disposed in the housing 210. The light 253 travels from the backlight module 250, passes through the polarizer 242, the display panel 220 and the polarizing glasses 241′ to eyes 10 of user.

The polarizing glasses 241′ can be circular polarized.

The diffusion film 252 and the brightness enhancement film 251 are located between the polarizer 242 and the backlight module 250.

Utilizing the display device 200′ of FIG. 8, only the user wearing the polarizing glasses can watch the image displayed by the display device, and the privacy of user is therefore improved.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a housing, wherein an opening is formed on the housing, a first polarizer groove is formed in the housing communicated to the opening, and a second polarizer groove is formed in the housing communicated to the opening;
a display panel, disposed in the housing;
a circuit control panel, electrically connected to the display panel;
a first polarizer, detachably disposed in the housing, wherein the first polarizer slides in the first polarizer groove of the housing relative to the display panel; and
a second polarizer, detachably disposed in the housing, wherein the second polarizer slides in the second polarizer groove of the housing relative to the display panel, wherein the display panel is located between the first polarizer and the second polarizer.

2. The display device as claimed in claim 1, further comprising:
a backlight module, disposed in the housing;
a brightness enhancement film, detachably disposed in the housing, wherein a brightness enhancement film groove is formed in the housing communicated to the opening, and the brightness enhancement film slides in the brightness enhancement film groove of the housing relative to the backlight module;
a diffusion film, detachably disposed in the housing, wherein a diffusion film groove is formed in the housing communicated to the opening, and the diffusion film slides in the diffusion film groove of the housing relative to the backlight module, wherein the brightness enhancement film and the diffusion film are located between the backlight module and the second polarizer.

3. The display device as claimed in claim 2, wherein a first distance is formed between the diffusion film and the backlight module, and the first distance is smaller than 5 mm.

4. The display device as claimed in claim 2, wherein a second distance is formed between the brightness enhancement film and the diffusion film, and the second distance is smaller than 5 mm.

5. The display device as claimed in claim 1, wherein the circuit control panel is facing to the opening.

6. The display device as claimed in claim 1, further comprising a lenticular lens member, detachably disposed in the housing, and sliding relative to the display panel, wherein the first polarizer is located between the display panel and the lenticular lens member.

7. The display device as claimed in claim 1, further comprising a touch panel, disposed in the housing and electrically connected to the circuit control panel, wherein the first polarizer is located between the display panel and the touch panel.

8. The display device as claimed in claim 1, wherein the first polarizer is circular polarized.

9. A display device, comprising:
a backlight module, providing a light;
a housing;
a display panel, disposed in the housing;
a circuit control panel, electrically connected to the display panel;
a polarizer, disposed in the housing; and
a polarizing glasses, wherein the light travels from the backlight module, passes through the polarizer, the display panel and the polarizing glasses to eyes of user.

10. The display device as claimed in claim 9, wherein the polarizing glasses is circular polarized.

11. The display device as claimed in claim 9, further comprising a diffusion film and a brightness enhancement film located between the polarizer and the backlight module.
